(19) United States
(12) Patent Application Publication
(10) Pub. No.: US 2026/0175433 A1
(43) Pub. Date: Jun. 25, 2026

(54) TECHNIQUES FOR CONTROLLING ACTUATED SYSTEMS USING NON-DETERMINISTIC DATA

(71) Applicant: DISNEY ENTERPRISES, INC., Burbank, CA (US)

(72) Inventors: Paul FULLER, Winter Garden, FL (US); Jerry FRAME, Winter Garden, FL (US); Guirec Gérard Henri François MALOISEL, Zürich (CH)

(21) Appl. No.: 19/000,465

(22) Filed: Dec. 23, 2024

(51) Int. Cl. B25J 9/16

(52) U.S. Cl. CPC B25J 9/1694

(57) ABSTRACT

A method for controlling an actuated system includes receiving one or more data points, where each data point included in the one or more data points associates animation data with a different point in time, computing a curve based on the one or more data points, and causing the actuated system to perform a motion based on the curve.

### BACKGROUND

### Technical Field

Embodiments of the present disclosure relate generally to computer science and robotics and, more specifically, to techniques for controlling actuated systems using non-deterministic data.

### Description of the Related Art

Robots are being increasingly used to perform tasks automatically or autonomously in various environments. For example, in a theme park setting, robots can interact with guests to provide more personalized theme park experiences to those guests. As another example, in a factory setting, robots can be used to assemble different objects together to produce an end-product or part.

Conventional robot controllers oftentimes require the data that is used to control robots be generated and delivered to those controllers at a deterministic rate that does not change. Data that is generated at a deterministic rate is also referred to herein as “deterministic data,” and data that is not generated at a deterministic rate is referred to herein as “non-deterministic data.” For example, if a robot controller expects to receive data in 10 millisecond intervals, any amount of deviation or jitter in the way the data is generated and delivered to the robot controller can cause the robot to shake, cause the robot to make rough motions, or potentially cause the robot to malfunction or operate with errors. Conventionally, data used to control robots cannot be generated by applications that do not meet this deterministic requirement. For example, applications running on common operating systems that are not real-time operating systems are typically incapable of generating deterministic data. Accordingly, conventional robots cannot be effectively controlled using such applications. Even if an application itself is able to generate deterministic data, such data cannot be used to effectively control a conventional robot if the data needs to be transmitted over a network that introduces jitter in the delivery of the data to a robot controller.

One approach for ensuring that data is delivered to a robot controller at a deterministic rate is to use high-performance hardware to execute an application that generates the data. The high-performance hardware can also be limited to executing the application that generates the data, without executing other processes at the same time. Doing so helps ensure that the application runs smoothly and generates data at close to a deterministic rate. One drawback of this approach, however, is that high-performance hardware is typically difficult to operate. For example, high-performance hardware can consume significant amounts of energy, require larger physical spaces and cooling systems for operation, and have complex maintenance requirements. Further, even when executing on high-performance hardware, some applications are not always able to generate data at the deterministic rates required by robot controllers. In addition, the high-performance hardware is limited to executing applications that generate data, without being able to execute other processes at the same time.

Another approach for ensuring that data is delivered to a robot at a deterministic rate is to pre-compute the data. With this approach, even if the data is not pre-computed at a deterministic rate, the pre-computed data itself can be transmitted to the robot controller at a deterministic rate. One drawback of using pre-computed data, though, is that a robot being controlled using pre-computed data can only move in accordance with the pre-computed data. Consequently, the robot is usually not able to adjust in real-time to changes in the environment. For example, a robot being controlled using pre-computed data most likely would not be able to interact with a theme park guest in real-time outside of the specific interactions defined by the pre-computed data.

As the foregoing illustrates, what is needed in the art are more effective techniques for controlling robots.

### SUMMARY

One embodiment of the present disclosure sets forth a computer-implemented method for controlling an actuated system. The method includes receiving one or more data points, where each data point included in the one or more data points associates animation data with a different point in time. The method further includes computing a curve based on the one or more data points. In addition, the method includes causing the actuated system to perform a motion based on the curve.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that the disclosed techniques enable actuated systems, such as robots, to be controlled using non-deterministic data that is not generated at deterministic rates, even when controllers of the actuated systems require data to be delivered at deterministic rates. The non-deterministic data can be generated without using high-performance hardware, and in a manner that is less restrictive on other processes running on the same hardware. The non-deterministic data can also be generated in real-time, including in response to changes in the environment. In addition, the non-deterministic data can be transmitted over one or more networks that introduce jitter before the non-deterministic data is used to control the actuated systems. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a system configured to implement one or more aspects of the various embodiments;

FIG. 2 is a more detailed illustration of the source computing device of FIG. 1, according to various embodiments;

FIG. 3 is a more detailed illustration of the target computing device of FIG. 1, according to various embodiments;

FIG. 4 illustrates an exemplar update to the data table of FIG. 1, according to various embodiments;

FIG. 5 illustrates an exemplar curve computed using the data table of FIG. 1, according to various embodiments;

FIG. 6 is a flow diagram of method steps for controlling a robot, according to various embodiments; and

FIG. 7 is a flow diagram of method steps for computing a curve that is used to animate a robot, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

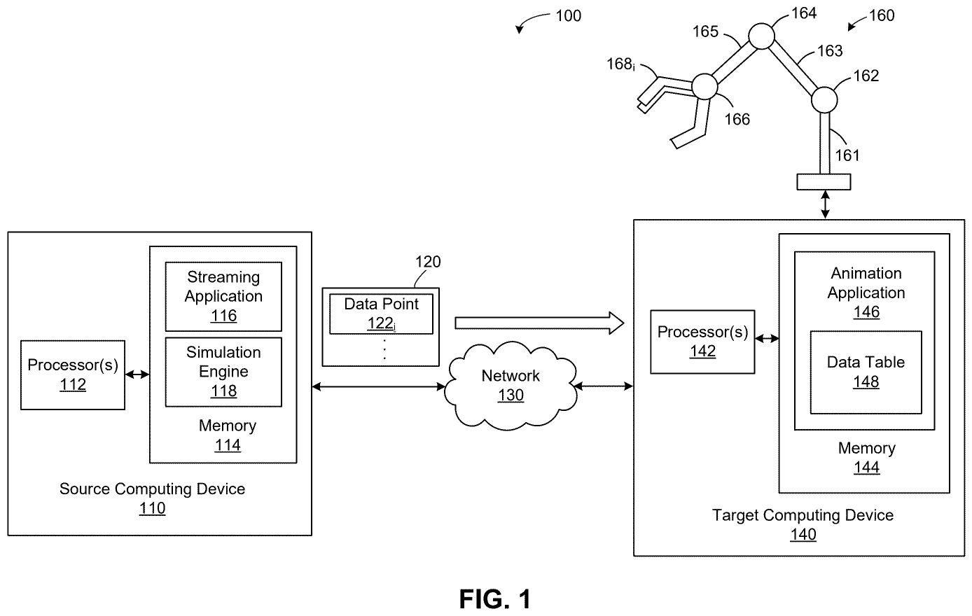

FIG. 1 illustrates a block diagram of a system 100 configured to implement one or more aspects of the various embodiments. As shown, the system 100 includes a source computing device 110, which is configured to generate non-deterministic data, and a target computing device 140, which is configured to control a robot 160 using the non-deterministic data. Although described herein primarily with respect to robots as a reference example, in some embodiments, techniques disclosed herein can be applied to control any actuated systems that include one or more components and one or more actuators configured to actuate the one or more components. For example, when the actuated system is a robot, the components could be links of the robot, and the actuators could be joint motors that allow joints between the links the robot to rotate and/or move linearly. As another example, the actuated system could be the motion base of a vehicle, which is a platform that is affixed to the vehicle and can be controlled to move in multiple directions via attached actuators, causing motions that simulate different types of movements of the vehicle. As yet another example, the actuated system could be show action equipment that is a motion-based system, such as curtains or walls attached to actuators that can raise and lower the curtains or walls, a mechanism for moving an object (e.g., an animatronic character) along a path, or the like. Show action equipment can be used in theme park attractions, among other places. Similar to robots, other actuated systems, such as vehicle motion bases and show action equipment, oftentimes rely on controllers that require deterministic data and can, therefore, be susceptible to deviation or jitter in the way data is generated and delivered to those actuated systems. Techniques disclosed herein permit data to be streamed to actuated systems and used to compute curves for controlling actuators of the actuated systems according to values along the curves, as discussed in greater detail below. For example, data can be streamed over a network from a computing system at a remote location, such as a server that controls multiple actuated systems and can coordinate and synchronize motion performances across the actuated systems, which is in contrast to some conventional actuated systems, such as conventional vehicle motion bases, that require data to reside on controllers attached to the actuated systems.

The source computing device 110 and the target computing device 140 are in communication over a network 130. The network 130 can be a wide area network (WAN) such as the Internet, a local area network (LAN), a cellular network, and/or any other suitable network. Although shown as communicating over the network 130 for illustrative purposes, in some embodiments, a source computing device and a target computing device can communicate directly (e.g., via a direct cable connection), without use of a network. In some other embodiments, the source computing device 110 and the target computing device 140 can be combined into a single computing device executing applications that communicate with each other.

As shown, a streaming application 116 and a simulation engine 118 execute on one or more processors 112 of the source computing device 110 and are stored in a memory 114 of the source computing device 110. The processor(s) 112 receive user input from input devices, such as a keyboard or a mouse. The processor(s) 112 can include one or more primary processors of the source computing device 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The memory 114 of the source computing device 110 stores content, such as software applications and data, for use by the processor(s) 112 and the GPU(s) and/or other processing units. The memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the memory 114. The storage can include any number and type of external memories that are accessible to the processor(s) 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

The source computing device 110 shown herein is for illustrative purposes only, and variations and modifications are possible without departing from the scope of the present disclosure. For example, the number of processor(s) 112, the number of GPUs and/or other processing unit types, the number of system memories (e.g., memory 114), and/or the number of applications included in the memory 114 can be modified as desired. Further, the connection topology between the various units in FIG. 1 can be modified as desired. In some embodiments, any combination of the processor(s) 112, the memory 114, and/or GPU(s) can be included in and/or replaced with any type of virtual computing system, distributed computing system, and/or cloud computing environment, such as a public, private, or a hybrid cloud system.

In some embodiments, the streaming application 116 is configured to record animation data from a simulation executed by the simulation engine 118, as well as times for playing the animation data. The animation data corresponds to intended motion(s) of the robot 160 (or another actuated system) and can be used to compute curves for controlling motors of the robot 160 (or other actuated system) in a deterministic manner, as discussed in greater detail below. In some embodiments, the animation data can include joint angles, linear motions (e.g., in mm, inches, etc.), and/or any arbitrary units for controlling motors of the robot 160, and the times can be timestamps that each include a date and time, which can be obtained directly from the simulation or computed from times obtained from the simulation. For example, the animation data could include angles, linear motions, and/or any other arbitrary units to be achieved by motors at the joints of the robot 160. More generally, in some embodiments, the animation data can include any suitable data for controlling the actuators of an actuated system. Further, the animation data can include non-deterministic data that is not generated at deterministic rates by the simulation engine 118. In some embodiments, the simulation engine 118 can be a game engine or other real-time rendering system, physics engine, or the like. Further, in some embodiments, the simulation engine 118 can execute on an operating system (OS) that is not a real-time OS. For example, when the simulation engine 118 is a game engine and the actuated system is a robot, the streaming application 116 could record animation data from the game engine that includes robot joint motor angles, linear motions, and/or other arbitrary units as well as times for playing the joint motor angles, linear motions, and/or other arbitrary units whenever the game engine renders a frame. It should be understood that the frames can be rendered by the game engine at varying frame rates and are, therefore, not deterministic. In some embodiments, the animation data can be generated in real-time. For example, the real-time animation data could be generated based on sensor data captured by one or more sensors (e.g., cameras, light detection and ranging (LiDAR), time-of-flight sensors, etc.) mounted on the robot 160 (or other actuated system) or within the environment. As a specific example, the sensor data could include the motions and/or expressions of a user, and the simulation engine 118 can simulate a response of the robot 160 (or other actuated system) to the sensor data.

The streaming application 116 generates and transmits, to an animation application 146, packets that include animation data and times for playing the animation data. Illustratively, a packet 120 includes data points 122ᵢ (referred to herein collectively as data points 122 and individually as a data point 122) that each include a timestamp and corresponding animation data. Although described herein primarily with respect to packets as a reference example, animation data and associated times can be transmitted in any technically feasible manner in some embodiments. In some embodiments, each of the data points 122 in the packet 120 can be specific to a particular joint of the robot 160 that is actuatable by a joint motor. More generally, each data point in a packet can be specific to a particular actuator of an actuated system in some embodiments. Each data point 122 can also include an identifier (ID) of the particular joint (or other actuator) associated with the data point 122.

As shown, the animation application 146 is stored in a memory 144, and executes on a processor(s) 142, of the target computing device 140. Upon receiving packets that include animation data and times, such as the packet 120, from the streaming application 116, the animation application 146 stores the animation data and times in a data table 148. Although described herein primarily with respect to the data table 148 as a reference example, in some embodiments, animation data and times can be stored in any technically feasible manner, such as using a queue, a list, a file, etc. The animation application 146 computes curves for animating the robot 160 (or other actuated system) using the stored animation data and times. For example, when the animation data includes joint angles, linear motions, and/or other arbitrary units for controlling motors of the robot 160, in some embodiments, the animation application 146 can compute, for each joint of the robot 160, a curve that is a cubic Hermite spline passing through corresponding animation data points that are stored in the data table 148. The computed curves can, in turn, be used to obtain deterministic values for the joint angles, linear motions, and/or other arbitrary units at specific times along the curves. Then, the animation application 146 can cause the robot 160 (or other actuated system) to move according to the deterministic values. Continuing the above example, the animation application could transmit the joint angles, linear motions, and/or other arbitrary units at deterministic time intervals on the cubic Hermite spline to the robot 160 (or other actuated system) or a controller thereof (not shown), causing the robot 160 (or other actuated system) to move.

As shown, the robot 160 includes multiple links 161, 163, and 165 that are rigid members, as well as joints 162, 164, and 166 that are movable components that can be actuated to cause relative motion between adjacent links. In addition, the robot 160 includes multiple fingers 168ᵢ (referred to herein collectively as fingers 168 and individually as a finger 168). Although an example robot 160 is shown for illustrative purposes, in some embodiments, techniques disclosed herein can be applied to control any suitable actuated system, including robots that have different joints, links, and/or fingers; vehicle motion bases; show action equipment; etc.

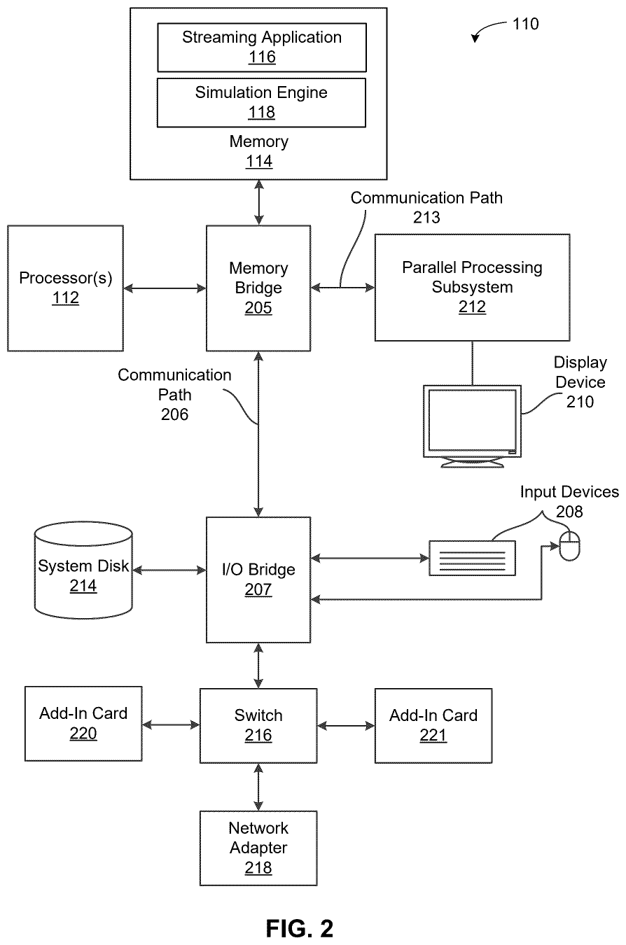

FIG. 2 is a block diagram illustrating the source computing device 110 of FIG. 1 in greater detail, according to various embodiments. The source computing device 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the source computing device 110 is a server machine operating in a data center or a cloud computing environment that provides scalable computing resources as a service over a network.

In various embodiments, the source computing device 110 includes, without limitation, the processor(s) 112 and the memory(ies) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In some embodiments, the I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, the source computing device 110 may be a server machine in a cloud computing environment. In such embodiments, the source computing device 110 may not include input devices 208, but may receive equivalent input information by receiving commands (e.g., responsive to one or more inputs from a remote computing device) in the form of messages transmitted over a network and received via the network adapter 218. In some embodiments, the switch 216 is configured to provide connections between the I/O bridge 207 and other components of the source computing device 110, such as a network adapter 218 and various add-in cards 220 and 221.

In some embodiments, the I/O bridge 207 is coupled to a system disk 214 that may be configured to store content and applications and data for use by the processor(s) 112 and the parallel processing subsystem 212. In some embodiments, the system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to the I/O bridge 207 as well.

In various embodiments, the memory bridge 205 may be a Northbridge chip, and the I/O bridge 207 may be a Southbridge chip. In addition, the communication paths 206 and 213, as well as other communication paths within the source computing device 110, may be implemented using any technically suitable protocols, including, without limitation, AGP (Accelerated Graphics Port), HyperTransport, or any other bus or point-to-point communication protocol known in the art.

In some embodiments, the parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within the parallel processing subsystem 212 that are configured to perform such general purpose and/or compute operations. In yet other embodiments, the one or more PPUs included within the parallel processing subsystem 212 may be configured to perform graphics processing, general purpose processing, and/or compute processing operations. In some embodiments, the memory 114 includes at least one device driver configured to manage the processing operations of the one or more PPUs within the parallel processing subsystem 212. In addition, the memory 114 includes the streaming application 116 and the simulation engine 118. In some embodiments, the streaming application 116 and the simulation engine 118 can execute on an OS (not shown), such as Linux®, Microsoft Windows®, or macOS®, that is also stored in the memory 144. Although described herein primarily with respect to the streaming application 116 and the simulation engine 118, techniques disclosed herein can also be implemented, either entirely or in part, in other software and/or hardware, such as in the parallel processing subsystem 212.

In various embodiments, the parallel processing subsystem 212 may be integrated with one or more of the other elements of FIG. 2 to form a single system. For example, the parallel processing subsystem 212 may be integrated with the processor(s) 112 and other connection circuitry on a single chip to form a system on a chip (SoC).

In some embodiments, the processor(s) 112 include the primary processor(s) of source computing device 110, controlling and coordinating operations of other system components. In some embodiments, the processor(s) 112 issue commands that control the operation of PPUs. In some embodiments, the communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

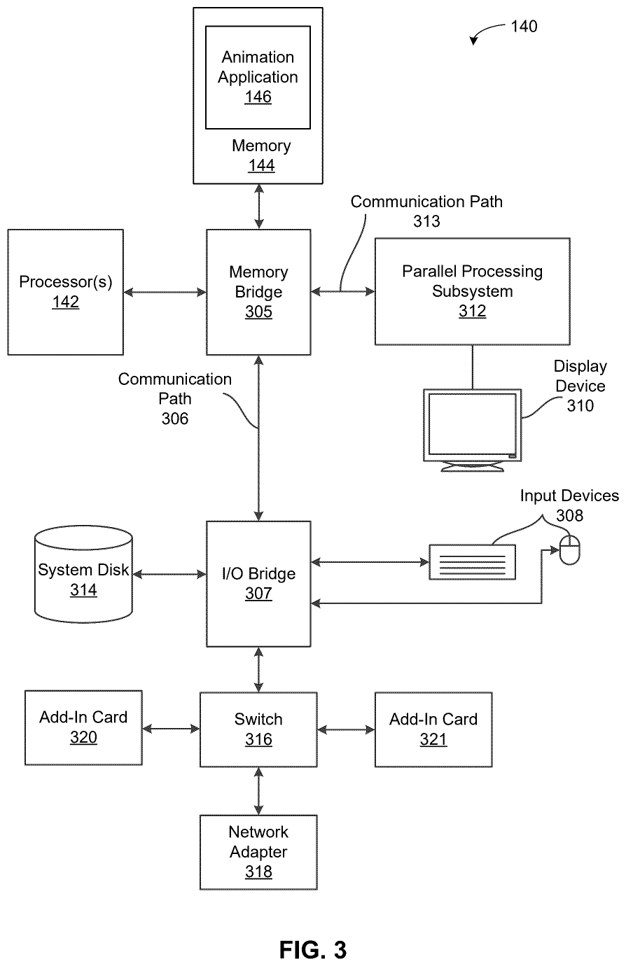

FIG. 3 is a block diagram illustrating the target computing device 140 of FIG. 1 in greater detail, according to various embodiments. The target computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the target computing device 140 is a server machine operating in a data center or a cloud computing environment that provides scalable computing resources as a service over a network.

In various embodiments, the target computing device 140 includes, without limitation, the processor(s) 142 and the memory(ies) 144 coupled to a parallel processing subsystem 312 via a memory bridge 305 and a communication path 313. The memory bridge 305 is further coupled to an I/O (input/output) bridge 307 via a communication path 306, and I/O bridge 307 is, in turn, coupled to a switch 316.

In some embodiments, the I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the target computing device 140 may be a server machine in a cloud computing environment. In such embodiments, the target computing device 140 may not include the input devices 308, but may receive equivalent input information by receiving commands (e.g., responsive to one or more inputs from a remote computing device) in the form of messages transmitted over a network and received via the network adapter 318. In some embodiments, the switch 316 is configured to provide connections between the I/O bridge 307 and other components of the target computing device 140, such as a network adapter 318 and various add-in cards 320 and 321.

In some embodiments, the I/O bridge 307 is coupled to a system disk 314 that may be configured to store content and applications and data for use by the processor(s) 142 and the parallel processing subsystem 312. In some embodiments, the system disk 314 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to the I/O bridge 307 as well.

In various embodiments, the memory bridge 305 may be a Northbridge chip, and the I/O bridge 307 may be a Southbridge chip. In addition, the communication paths 306 and 313, as well as other communication paths within target computing device 140, may be implemented using any technically suitable protocols, including, without limitation, AGP (Accelerated Graphics Port), HyperTransport, or any other bus or point-to-point communication protocol known in the art.

In some embodiments, the parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more parallel processing units (PPUs), also referred to herein as parallel processors, included within the parallel processing subsystem 312.

In some embodiments, the parallel processing subsystem 312 incorporates circuitry optimized (e.g., that undergoes optimization) for general purpose and/or compute processing. Again, such circuitry may be incorporated across one or more PPUs included within the parallel processing subsystem 312 that are configured to perform such general purpose and/or compute operations. In yet other embodiments, the one or more PPUs included within the parallel processing subsystem 312 may be configured to perform graphics processing, general purpose processing, and/or compute processing operations. In some embodiments, the memory 144 includes at least one device driver configured to manage the processing operations of the one or more PPUs within the parallel processing subsystem 312. In addition, the memory 144 includes the animation application 146. In some embodiments, the animation application 146 can execute on an OS (not shown), such as Linux®, Microsoft Windows®, or macOS®, that is also stored in the memory 144. Although described herein primarily with respect to the animation application 146, techniques disclosed herein can also be implemented, either entirely or in part, in other software and/or hardware, such as in the parallel processing subsystem 312.

In various embodiments, the parallel processing subsystem 312 may be integrated with one or more of the other elements of FIG. 3 to form a single system. For example, the parallel processing subsystem 312 may be integrated with processor(s) 142 and other connection circuitry on a single chip to form a system on a chip (SoC).

In some embodiments, the processor(s) 142 include the primary processor(s) of the target computing device 140, controlling and coordinating operations of other system components. In some embodiments, the processor(s) 142 issue commands that control the operation of PPUs. In some embodiments, the communication path 313 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the systems shown herein are illustrative and that variations and modifications are possible. The connection topology, including the number and arrangement of bridges, the number of processors, and the number of parallel processing subsystems, may be modified as desired. For example, in some embodiments, the memory 114 (or 144) could be connected to the processor(s) 112 (or 142) directly rather than through the memory bridge 205 (or 305), and other devices may communicate with the memory 114 (or 144) via the memory bridge 205 (or 305) and the processor(s) 112 (or 142). In other embodiments, the parallel processing subsystem 212 (or 312) may be connected to the I/O bridge 207 (or 307) or directly to the processor(s) 112 (or 142), rather than to the memory bridge 205 (or 305). In still other embodiments, the I/O bridge 207 (or 307) and the memory bridge 205 (or 305) may be integrated into a single chip instead of existing as one or more discrete devices. In certain embodiments, one or more components shown in FIGS. 2 and/or 3 may not be present. For example, the switch 216 (or 316) could be eliminated, and the network adapter 218 (or 318) and the add-in cards 220, 221 (or 320, 321) would connect directly to the I/O bridge 207 (or 308). Lastly, in certain embodiments, one or more components shown in FIGS. 2 and/or 3 may be implemented as virtualized resources in a virtual computing environment, such as a cloud computing environment. In particular, the parallel processing subsystem 212 (or 312) may be implemented as a virtualized parallel processing subsystem in at least one embodiment. For example, the parallel processing subsystem 212 (or 312) may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Controlling Actuated Systems Using Non-Deterministic Data

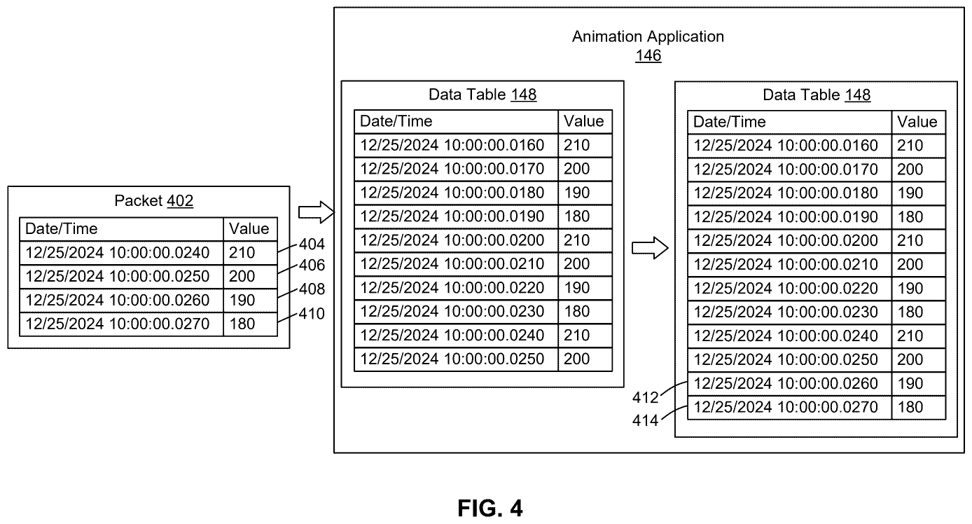

FIG. 4 illustrates an exemplar update to the data table 148 of FIG. 1, according to various embodiments. As shown, the animation application 146 updates the data table 148 using data points 404, 406, 408, and 410 in a packet 402 that is received from the streaming application 116. As described, the streaming application 116 can generate packets, such as the packet 402, that include animation data and times the animation data should be played. The animation data can include non-deterministic data that is not generated at deterministic rates, such as data output by the simulation engine 118, and the streaming application 116 can transmit packets including such data over one or more networks (e.g., the network 130) to the animation application 146. In some embodiments, the animation data can be generated in real-time, such as based on sensor data captured by one or more sensors mounted on a robot (e.g., the robot 160) or other actuated system, or within an environment. For example, the sensor data could include the motions and/or expressions of a user, and the simulation engine 118 can simulate a response of a robot (or other actuated system) to the sensor data, which can involve changes in joint motor angles, linear motions, and/or any other arbitrary units that can be included in data points (e.g., the data points 404, 406, 408, and/or 410) of a packet (e.g., the packet 402).

Illustratively, each of the data points 404, 406, 408, and 410 in the packet 402 includes a time, shown as a date/time timestamp, and corresponding animation data, shown as a value. As described, in some embodiments, the animation data can include joint angles, linear motions, and/or any other arbitrary units for controlling the motors of a robot. More generally, the animation data can include any suitable data for controlling the actuators of an actuated system, such as a vehicle motion base or show action equipment, in some embodiments. For example, the value for animation data in each of the data points 404, 406, 408, and 410 could be a joint angle, linear motion, and/or other arbitrary unit to be achieved by a robot joint motor. A packet can include any number of data points that are associated with any number of robot joint motors (or actuators of any other suitable actuated system) in some embodiments. For example, in some embodiments, each packet can include, for each of one or more robot joint motors (or actuator(s) of an actuated system), (1) four data points (e.g., data points 404, 406, 408, and 410) that each include a robot joint motor angle, linear motion, and/or other arbitrary unit (or any other suitable data for controlling an actuator) and (2) a time, because four data points are required to compute some curves, such as a cubic Hermite spline. In some embodiments, each data point 404, 406, 408, or 410 can also include an ID (not shown) of the joint associated with the data point 404, 406, 408, or 410. In some embodiments, in addition to the data points 404, 406, 408, and 410, the packet 402 can include a date/timestamp (not shown) representing the current data/time of the source computing device 110. In such cases, the date/timestamp representing the current date/time of the source computing device 110 can be used for synchronization between the source computing device 110 and the target computing device 140 via, e.g., a phase-lock loop technique.

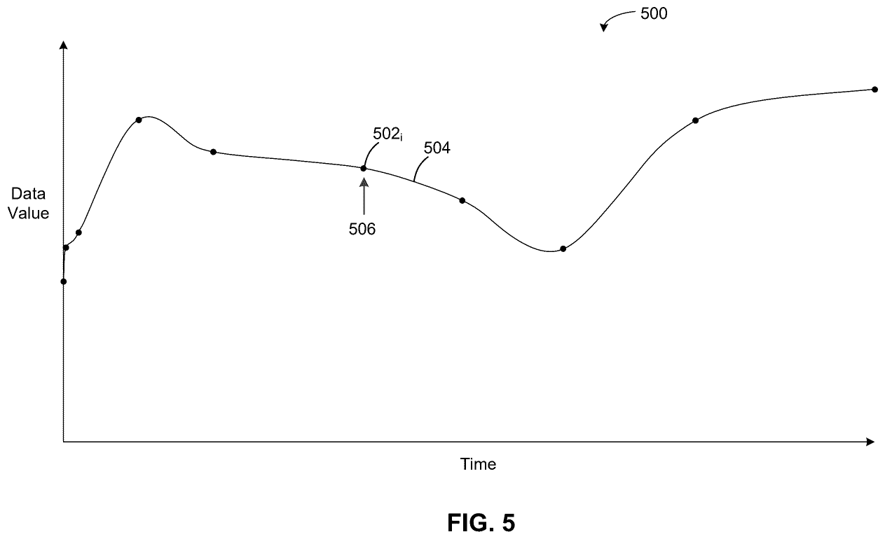

Upon receiving packets, such as the packet 402, from the streaming application 116, the animation application 146 stores animation data and times from the packets in the data table 148. In some embodiments, the animation application 146 first compares the animation data and times from the packet 402 with existing entries in the data table 148. In such cases, the animation application 146 can create new entries and/or modify existing entries in the data table 148 to store any portions of the animation data and times that are not already stored in the data table 148. Illustratively, the packet 402 includes duplicate data points 404 and 406, which were previously transmitted in other packet(s), for redundancy purposes. Inclusion of the duplicate data points 404 and 406 permits the animation data and times in those data points 404 and 406 to be added to the data table 148 even if the previous packet(s) that included the same animation data and times had not reached the animation application 146 because, e.g., those previous packet(s) had been lost during transmission over the network 130. Accordingly, the inclusion of duplicate data points in packets can provide redundancy in case of packet loss, as well potentially allow data points to be updated with newer values. In addition, the packet 402 includes new data points 408 and 410 that include animation data and times that are missing from the data table 148. Upon identifying the new data points 408 and 410, the animation application 146 adds entries 412 and 414 to the data table 148 that store the data points 408 and 410, including the animation data and times therein. Thereafter, the animation application 146 can compute curves for animating a robot (e.g., the robot 160) or other actuated system using the animation data and times that are stored in the data table 148, as described in greater detail below in conjunction with FIG. 5. In some embodiments, the data table 148 can also be limited to a maximum number of entries (e.g., 500 entries), after which the oldest entries can be deleted when new entries are added.

FIG. 5 illustrates an exemplar curve computed using the data table 148 of FIG. 1, according to various embodiments. As shown, the curve is a cubic Hermite spline 504, which has been plotted on a graph 500 having an x-axis that represents time and a y-axis that represents animation data values. Illustratively, the cubic Hermite spline 504 is computed to pass through data points 502ᵢ (referred to herein collectively as data points 502 and individually as a data point 502) that are stored in the data table 148. For example, the data points 502 could represent joint angles, linear motions, and/or any other arbitrary units for a particular joint of a robot (e.g., robot 160), or any other suitable data for controlling an actuator of an actuated system, at different times, and the data points 502 can be received via one or more packets and stored in the data table 148, as described above in conjunction with FIGS. 1 and 4. It should be noted that the data points 502 do not need to be an equal time distance apart. Although described herein primarily with respect to computing cubic Hermite splines as a reference example, any technically feasible curves that pass through, or substantially through, data points can be computed in some embodiments. For example, other spline/interpolation algorithms can be used to compute the curves in some embodiments.

In some embodiments, the animation application 146 can compute the cubic Hermite spline 504 for a window of time after a current animation time 506, assuming that data points for the window of time have been received from the streaming application 116. In such cases, the animation application 146 can pre-compute tangents to the data points 502. Then, the animation application 146 can select an in-between time that is between two consecutive times from the time window that are stored in the data table 148. The two consecutive times can be times in the time window that are at or after the current animation time 506, for which a portion of the cubic Hermite spline 504 needs to be computed. Data points are available for each of the two-consecutives times, but not for in-between times between the two consecutive times. In some embodiments, each in-between time can be a deterministic time when a controller, such as a robot controller or a controller of an actuated system, expects to receive animation data. In some embodiments, the animation application 146 computes a curve at an in-between time as a cubic Hermite spline on a single interval between the two consecutive times. More formally, the cubic Hermite spline can be computed by interpolating animation data at the in-between time t in the interval (tₖ, tₖ₊₁) between two consecutive times at which animation data is known according to:

$$p ( t ) = {h}_{00} ( u ) {p}_{k} + {h}_{10} ( u ) ( {t}_{k + 1} - {t}_{k} ) {m}_{k} + {h}_{01} ( u ) {p}_{k + 1} + {h}_{11} ( u ) ( {t}_{k + 1} - {t}_{k} ) {m}_{k + 1} , \qquad ( 1 )$$

where pₖ is a starting data point at time tₖ, pₖ₊₁ is an ending data point at time tₖ₊₁, mx is a starting tangent at time tₖ, mₖ₊₁ is an ending tangent at time tₖ₊₁, u=(t−tₖ)/(tₖ₊₁−tₖ) is the time remapped to [0,1] through an affine (degree−1) change of variable, and h refers to the Hermite basis functions. More specifically:

$$\{ \begin{matrix}{h}_{00} ( u ) = 2 {u}^{3} - 3 {u}^{2} + 1 \\ {h}_{10} ( u ) = {u}^{3} - 2 {u}^{2} + u \\ {h}_{01} ( u ) = - 2 {u}^{3} + 3 {u}^{2} \\ {h}_{11} ( u ) = {u}^{3} - {u}^{2}\end{matrix} \qquad ( 2 )$$

Further, each of the tangents can be computed as a three-point difference, not requiring constant interval lengths, according to:

$${m}_{k} = \frac{1}{2} ( \frac{{p}_{k + 1} - {p}_{k}}{{t}_{k + 1} - {t}_{k}} + \frac{{p}_{k} - {p}_{k - 1}}{{t}_{k} - {t}_{k - 1}} ) , \qquad ( 3 )$$

for internal points k=2, . . . , n−1, and one-sided difference at the endpoints of a data set.

The same computation can be repeated for other in-between times, until an in-between time that is beyond a later time from the two consecutive times is reached. When such an in-between time is reached, the animation application 146 switches to a next two consecutive times from the time window that are stored in the data table 148.

Thereafter, the animation application 146 can transmit the animation data values along the cubic Hermite spline 504 at the computed times to a controller of the robot or other actuated system (e.g., a proportional derivative (PD) controller, a proportional-integral controller (PID) controller, a state space controller, a fuzzy logic controller, a neural network controller, or the like) or the robot or other actuated system itself, causing the robot or other actuated system to move according to the animation data. In particular, the animation data values along the cubic Hermite spline 504 can be transmitted to the controller or robot (or other actuated system) at a deterministic (i.e., predefined) rate expected by the controller or robot (or other actuated system). Accordingly, non-deterministic data that may be heavily jittered, or not even cyclic at all, can be used to compute curves that provide deterministic data for the controller or robot (or other actuated system). The only requirement is that the animation application 146 receives the non-deterministic data before such data is needed to compute the curves. To satisfy such a requirement, the robot or other actuated system can be controlled by the animation application 146 at a delay to, such as a few hundred milliseconds behind, when the animation data is generated.

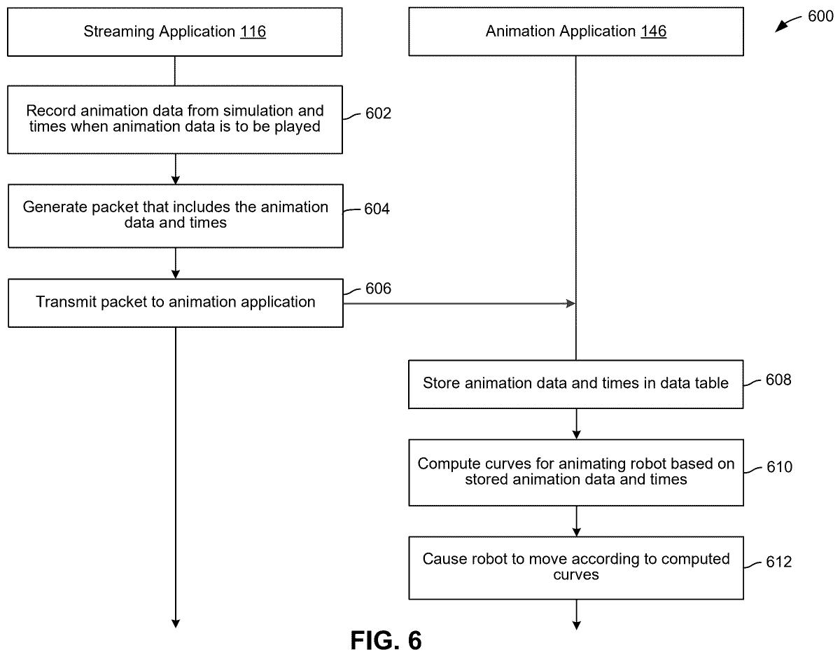

FIG. 6 is a flow diagram of method steps for controlling a robot, according to various embodiments. Although the method steps are described in conjunction with the systems of FIGS. 1-3, persons skilled in the art will understand that any system configured to perform the method steps in any order falls within the scope of the present embodiments.

As shown, a method 600 begins at step 602, where the streaming application 116 records animation data from a simulation and times when the animation data is to be played. In some embodiments, the animation data can include joint angles, linear motions, and/or any other arbitrary units for controlling the motors of a robot. For example, the animation data can include joint angles, linear motions, and/or other arbitrary units to be achieved by the joint motors of a robot in some embodiments. More generally, the animation data can include any suitable data for controlling the actuators of an actuated system in some embodiments. In some embodiments, the times can be timestamps that each include a date and time, which can be obtained directly from the simulation or computed from times obtained from the simulation. In some embodiments, the simulation is generated by the simulation engine 118, which as described can include a game engine or other real-time rendering system, physics engine, or the like. For example, in some embodiments where the simulation engine 118 is a game engine and the actuated system is a robot, the streaming application 116 can record animation data that includes robot joint motor angles, linear motions, and/or other arbitrary units from the game engine, as well as times for playing the joint motor angles, linear motions, and/or other arbitrary units, from the game engine whenever a frame is rendered by the game engine. As described, even though the frames can be rendered by the game engine at varying frame rates and are, therefore, not deterministic, the animation data and associated times can be used to reconstruct a curve that provides deterministic data for controlling a robot or other actuated system.

At step 604, the streaming application 116 generates a packet that includes the animation data and times. In some embodiments, the packet can indicate, for each robot joint that is identified by an ID, a number of data points that each include (1) a joint motor angle, linear motion, and/or other unit; and (2) a time. For example, in some embodiments, four data points that each include (1) a joint motor angle, linear motion, and/or other arbitrary unit; and (2) a time can be included in the packet for each robot joint, because four data points are required to compute a cubic Hermite spline. More generally, each packet can indicate, for one or more actuators of an actuated system that are each identified by an ID, one or more (e.g., four) data points that each include (1) any suitable animation data, and (2) a time. In some embodiments, the packet can also include a date/timestamp representing the current date/time of a source computing device (e.g., source computing device 110), on which the streaming application 116 runs, which can be used to synchronize a target computing device (e.g., target computing device 140), on which the animation application 146 runs, with the source computing device via, e.g., a phase-lock loop technique.

At step 606, the streaming application 116 transmits the packet to the animation application 146. In some embodiments, the packet or any other suitable communication that includes the animation data and times can be transmitted from the source computing device, on which the streaming application 116 runs, to the target computing device, on which the animation application 146 runs, over one or more networks, via a direct connection, or in any other technically feasible manner.

At step 608, the animation application 146 stores the animation data and times in the data table 148. In some embodiments, the animation application 146 first compares the animation data and times with existing entries in the data table 148. In such cases, the animation application 146 can create new entries and/or modify existing entries in the data table 148 to store any portions of the animation data and times that are not already stored in the data table 148.

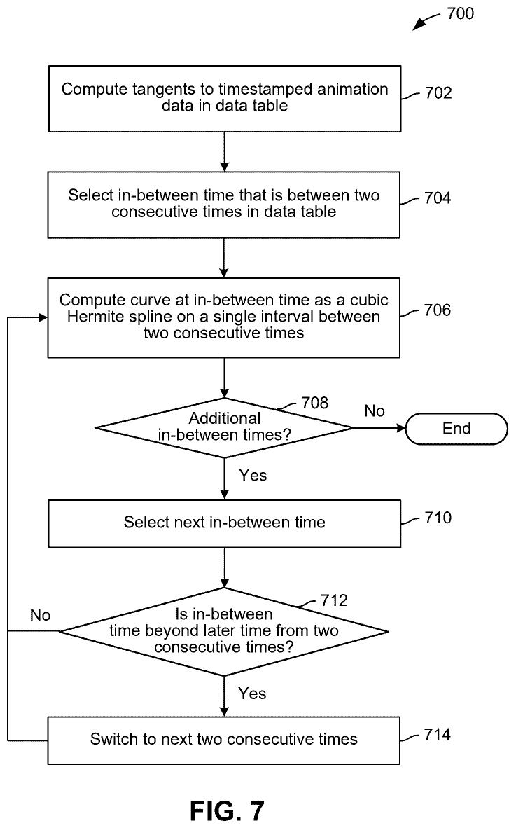

At step 610, the animation application 146 computes curves for animating a robot (or other actuated system) based on the stored animation data and times. For example, in some embodiments in which the animation data includes robot joint motor angles, linear motions, and/or other arbitrary units, the animation application 146 can compute, for each joint of the robot that can be actuated by a joint motor, a cubic Hermite spline that passes through the angles, linear motions, and/or other arbitrary units for the joint motor that are stored in the data table. In some embodiments, a cubic Hermite spline can be computed for a given joint motor (or other actuator of an actuated system) according to the steps of method 700, discussed below in conjunction with FIG. 7.

At step 612, the animation application 146 causes the robot (or other actuated system) to move according to the computed curves. In some embodiments, the animation application 146 can compute robot joint motor angles, linear motions, and/or other arbitrary units (or other animation data) at deterministic time intervals on the curve (e.g., a cubic Hermite spline), and then transmit signals that command the robot (or other actuated system) or a controller thereof (e.g., a PD controller, a PID controller, state space controller, fuzzy logic controller, neural network controller, or the like) to achieve the robot joint motor angles, linear motions, and/or other arbitrary units (or other animation data) at a deterministic rate expected by the controller or robot (or other actuated system), as described above in conjunction with FIG. 5.

FIG. 7 is a flow diagram of method steps for computing a curve that is used to animate a robot, according to various embodiments. Although the method steps are described in conjunction with the systems of FIGS. 1-3, persons skilled in the art will understand that any system configured to perform the method steps in any order falls within the scope of the present embodiments.

As shown, a method 700 begins at step 702, where the animation application 146 computes tangents to timestamped animation data in the data table 148. In some embodiments, the tangents are pre-computed, before being used to compute one or more curves.

At step 704, the animation application 146 selects an in-between time that is between the two consecutive times in the data table 148. The two consecutive times can be times that are at or after a current animation time, for which a curve needs to be computed. Data points are available in the data table 140 for each of the two-consecutives times, but not for the in-between time that is between the two consecutive times. In some embodiments, each in-between time can be a deterministic time that is between consecutive times for which data points are available in the data table 148, and each in-between time can also be a time at which a controller or robot (or other actuated system) expects to receive animation data. The times in the data table 148 and any in-between times can be sorted in increasing order of time in some embodiments. When animation data for multiple joints of a robot (or multiple actuators of another actuated system) are stored in the data table 148, steps 704-712 of the method 700 can be repeated to compute curves for each of the joints.

At step 706, the animation application 146 computes a curve at the in-between time as a cubic Hermite spline on a single interval between the two consecutive times.

At step 708, if there are no additional in-between times, then the method 700 ends. On the other hand, if there are additional in-between times, then the method continues to step 710, where the animation application 146, selects a next in-between time.

At step 712, if the selected in-between time is not beyond a later time from the two consecutive times, then the method 700 returns to step 706, where the animation application 146 again computes a curve at the selected in-between time as a cubic Hermite spline on a single interval between the two consecutive times.

On the other hand, if the selected in-between time is beyond a later time from the two consecutive times, then the method continues to step 714, where the animation application 146 switches to the next two consecutive times in the data table 148. Step 714 assumes that the next two consecutive times exist in the data table 148 and are within a time window for which the curve is being computed (if no such times exist, then the method 700 can end). Then, the method 700 returns to step 706, where the animation application 146 computes a curve at the selected in-between time as a cubic Hermite spline on a single interval between the next two consecutive times.

In sum, techniques are disclosed for controlling actuated systems, such as robots, using non-deterministic data. In some embodiments, a streamlining application records animation data from a simulation and times for playing the animation data. The streaming application generates and transmits, to an animation application, packets that include the animation data and the times for playing the animation data. Upon receiving such packets, the animation application stores the animation data and times in a data table. The animation application uses the stored animation data and times to compute curves for controlling the actuated system. Then, the animation application causes the actuated system to move according to values along the computed curves by transmitting the values to the actuated system or a controller thereof.

At least one technical advantage of the disclosed techniques relative to the prior art is that the disclosed techniques enable actuated systems, such as robots, to be controlled using non-deterministic data that is not generated at deterministic rates, even when controllers of the actuated systems require data to be delivered at deterministic rates. The non-deterministic data can be generated without using high-performance hardware, and in a manner that is less restrictive on other processes running on the same hardware. The non-deterministic data can also be generated in real-time, including in response to changes in the environment. In addition, the non-deterministic data can be transmitted over one or more networks that introduce jitter before the non-deterministic data is used to control the actuated systems. These technical advantages represent one or more technological improvements over prior art approaches.

1. In some embodiments, a computer-implemented method for controlling an actuated system comprises receiving one or more data points, wherein each data point included in the one or more data points associates animation data with a different point in time, computing a curve based on the one or more data points, and causing the actuated system to perform a motion based on the curve.

2. The computer-implemented method of clause 1, wherein the curve comprises a cubic Hermite spline.

3. The computer-implemented method of clauses 1 or 2, wherein causing the actuated system to perform the motion comprises transmitting one or more values along the curve to a controller of the actuated system at a predefined rate.

4. The computer-implemented method of any of clauses 1-3, wherein the animation data includes at least one of one or more angles, one or more linear motions, or one or more other units associated with one or more actuators included in the actuated system.

5. The computer-implemented method of any of clauses 1-4, wherein the animation data is generated by a simulation engine.

6. The computer-implemented method of any of clauses 1-5, wherein the animation data is generated in real-time in response to sensor data captured by one or more sensors.

7. The computer-implemented method of any of clauses 1-6, further comprising storing the one or more data points in a data table, wherein the curve is computed based on the one or more data points stored in the data table.

8. The computer-implemented method of any of clauses 1-7, wherein the one or more data points are received in one or more packets from a source computing device.

9. The computer-implemented method of any of clauses 1-8, wherein each packet included in the one or more packets further includes a current time associated with the source computing device, and the method further comprises performing one or more operations to synchronize a current time associated with a target computing device with the current time associated with the source computing device in each packet included in the one or more packets.

10. The computer-implemented method of any of clauses 1-9, wherein the actuated system comprises either a robot, a vehicle motion base, or show action equipment.

11. In some embodiments, one or more non-transitory computer-readable media store instructions that, when executed by at least one processor, cause the at least one processor to perform the steps of receiving one or more data points, wherein each data point included in the one or more data points associates animation data with a different point in time, computing a curve based on the one or more data points, and causing an actuated system to perform a motion based on the curve.

12. The one or more non-transitory computer-readable media of clause 11, wherein the curve comprises a cubic Hermite spline.

13. The one or more non-transitory computer-readable media of clauses 11 or 12, wherein causing the actuated system to perform the motion comprises transmitting one or more values along the curve to a controller of the actuated system at a predefined rate.

14. The one or more non-transitory computer-readable media of any of clauses 11-13, wherein the animation data includes at least one of one or more angles, one or more linear motions, or one or more other units associated with one or more actuators included in the actuated system.

15. The one or more non-transitory computer-readable media of any of clauses 11-14, wherein the animation data is generated by a game engine.

16. The one or more non-transitory computer-readable media of any of clauses 11-15, wherein the animation data is generated in real-time in response to sensor data captured by one or more sensors.

17. The one or more non-transitory computer-readable media of any of clauses 11-16, wherein the instructions, when executed by the at least one processor, further cause the at least one processor to perform the step of storing the one or more data points in a data table, wherein the curve is computed based on the one or more data points stored in the data table.

18. The one or more non-transitory computer-readable media of any of clauses 11-17, wherein the one or more data points are received in one or more packets from a source computing device, and wherein each packet included in the one or more packets includes a plurality of data points.

19. The one or more non-transitory computer-readable media of any of clauses 11-18, wherein the one or more data points are received via one or more networks that couple a plurality of computing devices together.

20. In some embodiments, a system comprises one or more memories storing instructions, and one or more processors that are coupled to the one or more memories and, when executing the instructions, are configured to receive one or more data points, wherein each data point included in the one or more data points associates animation data with a different point in time, compute a curve based on the one or more data points, and cause an actuated system to perform a motion based on the curve.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for controlling an actuated system, the method comprising:
receiving one or more data points, wherein each data point included in the one or more data points associates animation data with a different point in time;
computing a curve based on the one or more data points; and
causing the actuated system to perform a motion based on the curve.

2. The computer-implemented method of claim 1, wherein the curve comprises a cubic Hermite spline.

3. The computer-implemented method of claim 1, wherein causing the actuated system to perform the motion comprises transmitting one or more values along the curve to a controller of the actuated system at a predefined rate.

4. The computer-implemented method of claim 1, wherein the animation data includes at least one of one or more angles, one or more linear motions, or one or more other units associated with one or more actuators included in the actuated system.

5. The computer-implemented method of claim 1, wherein the animation data is generated by a simulation engine.

6. The computer-implemented method of claim 1, wherein the animation data is generated in real-time in response to sensor data captured by one or more sensors.

7. The computer-implemented method of claim 1, further comprising storing the one or more data points in a data table, wherein the curve is computed based on the one or more data points stored in the data table.

8. The computer-implemented method of claim 1, wherein the one or more data points are received in one or more packets from a source computing device.

9. The computer-implemented method of claim 8, wherein each packet included in the one or more packets further includes a current time associated with the source computing device, and the method further comprises performing one or more operations to synchronize a current time associated with a target computing device with the current time associated with the source computing device in each packet included in the one or more packets.

10. The computer-implemented method of claim 1, wherein the actuated system comprises either a robot, a vehicle motion base, or show action equipment.

11. One or more non-transitory computer-readable media storing instructions that, when executed by at least one processor, cause the at least one processor to perform the steps of:
receiving one or more data points, wherein each data point included in the one or more data points associates animation data with a different point in time;
computing a curve based on the one or more data points; and
causing an actuated system to perform a motion based on the curve.

12. The one or more non-transitory computer-readable media of claim 11, wherein the curve comprises a cubic Hermite spline.

13. The one or more non-transitory computer-readable media of claim 11, wherein causing the actuated system to perform the motion comprises transmitting one or more values along the curve to a controller of the actuated system at a predefined rate.

14. The one or more non-transitory computer-readable media of claim 11, wherein the animation data includes at least one of one or more angles, one or more linear motions, or one or more other units associated with one or more actuators included in the actuated system.

15. The one or more non-transitory computer-readable media of claim 11, wherein the animation data is generated by a game engine.

16. The one or more non-transitory computer-readable media of claim 11, wherein the animation data is generated in real-time in response to sensor data captured by one or more sensors.

17. The one or more non-transitory computer-readable media of claim 11, wherein the instructions, when executed by the at least one processor, further cause the at least one processor to perform the step of storing the one or more data points in a data table, wherein the curve is computed based on the one or more data points stored in the data table.

18. The one or more non-transitory computer-readable media of claim 11, wherein the one or more data points are received in one or more packets from a source computing device, and wherein each packet included in the one or more packets includes a plurality of data points.

19. The one or more non-transitory computer-readable media of claim 11, wherein the one or more data points are received via one or more networks that couple a plurality of computing devices together.

20. A system, comprising:
one or more memories storing instructions; and
one or more processors that are coupled to the one or more memories and, when executing the instructions, are configured to:
receive one or more data points, wherein each data point included in the one or more data points associates animation data with a different point in time,
compute a curve based on the one or more data points, and
cause an actuated system to perform a motion based on the curve.
